(19) United States
(12) Patent Application Publication
(10) Pub. No.: US 2014/0139208 A1
(43) Pub. Date: May 22, 2014

(54) ROTATION DETECTION DEVICE

(71) Applicant: DENSO CORPORATION, Kariya-city (JP)

(72) Inventor: Hiroyuki Tsuge, Nisshin-city (JP)

(73) Assignee: DENSO CORPORATION, Kariya-city (JP)

(21) Appl. No.: 14/075,246

(22) Filed: Nov. 8, 2013

(30) Foreign Application Priority Data
Nov. 20, 2012 (JP) 2012-254253

(51) Int. Cl. G01P 3/487; G01B 7/30

(52) U.S. Cl. CPC G01P 3/487; G01B 7/30
USPC 324/207.25

(57) ABSTRACT

A rotation detection device includes an encoder that is rotatably arranged, multiple detection object portions that are provided in the encoder and arranged in a circumferential direction, and a rotation detector for detecting rotation of the encoder. The rotation detector includes a detection portion for detecting the rotation of the encoder, a pulse generation portion for generating a pulse based on a detection signal that is outputted from the detection portion, a rotation speed calculation portion for calculating a first rotation speed of the encoder based on the pulse, a pulse counter for counting the pulse, an encoding portion for encoding information that includes the first rotation speed and a counter value of the pulse counter, and a communication portion for communicating the encoded information through unidirectional communication or interactive communication with an external device.

### CROSS REFERENCE TO RELATED APPLICATION

This application is based on Japanese Patent Application No. 2012-254253 filed on Nov. 20, 2012, the disclosure of which is incorporated herein by reference.

### TECHNICAL FIELD

The present disclosure relates to a rotation detection device with an encoder and a rotation detector.

### BACKGROUND

A conventional sensor for detecting a speed (hereinafter, referred to as a vehicle speed) of a vehicle simply outputs a pulse which is generated according to a rotation detection of an encoder. Conventionally, a resolution power (i.e., the number of pulses per turn of the encoder or sensitivity) of the encoder is around 50 pulses per turn. In a system for supporting a parking, traveling automatically, or the like, a control of a vehicle is performed until the vehicle stops. In a parking support, an automatic driving or the like, when the vehicle travels in very low speed, the resolution power of the encoder is not enough. Thus, it is required to improve resolution power of the encoder (e.g., 500 pulses per turn). However, when an output form (i.e., a pulse output) of a sensor is kept and the resolution power of the encoder improves, a frequency of the pulse will increase as the vehicle speed increases. When the vehicle travels in high speed, a calculation load on an ECU increases and it may be difficult to perform the calculation.

Conventionally, a technology providing the rotation detection device is disclosed (e.g., referring to JP-A-2011-27448 corresponding to US 2012/0116664A1). In the rotation detection device, a rotator is a detection object, and it is possible to select a detection resolution according to the rotation speed of a rotator. It is possible to process a signal for detecting rotation by a conventional process control device. The conventional process control device has a conventional resolution power to an input signal. The rotation detection device includes a multiplication device, a pulse generation device, a speed detection device and a pulse selection-and-output device. The multiplication device multiplies a phase of a detected electrode from a sensor output signal. The pulse generation device receives an output signal from the multiplication device to generate pulses having at least two different multiplications. The speed detection device detects the rotation speed of the rotator. The pulse selection-and-output device selects and outputs a pulse having a multiplication of pulses generated in the pulse generation device, according to the rotation speed detected by the rotation detection device. Incidentally, it may possible to be provided with a multiplication change device which changes a setting of multiplication of the pulse, which is generated by the pulse generation device. According to this configuration, it is possible to select the detection resolution according to the rotation speed of the rotator, and it is possible to change the multiplication of a rotation pulse that is outputted based on an instruction from the multiplication change device.

### SUMMARY It

is an object of the present disclosure to provide a rotation detection device. In the rotation detection device, it is possible to improve the resolution power and reduce the calculation load on the external apparatus. Furthermore, it is possible to prevent a false operation and an incorrect detection. Thus, a reliability of a rotation detection is improved. In addition, it is possible that the rotation detection device adds and outputs information other than the vehicle speed.

The rotation detection device includes an encoder that is rotatably arranged, a plurality of detection object portions, and a rotation detector. The plurality of detection object portions are provided in the encoder and arranged in a circumferential direction of the encoder. The rotation detector detects the rotation of the encoder. The rotation detector includes a detection portion, a pulse generation portion, a rotation speed calculation portion, a pulse counter, an encoding portion, and a communication portion. The detection portion detects the rotation of the encoder. The pulse generation portion generates a pulse based on a detection signal that is outputted from the detection portion. The pulse counter counts the pulse. The rotation speed calculation portion calculates a first rotation speed of the encoder based on the pulse. The encoding portion encodes information that includes the first rotation speed and a counter value of the pulse counter. The communication portion communicates encoded information, which is encoded by the encoding portion, through unidirectional communication or interactive communication with an external device.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a configuration example of a rotation detection device;

FIG. 2 is a diagram illustrating a first configuration example of an encoder;

FIG. 3 is a diagram illustrating a configuration example for determining a rotation direction of the encoder;

FIG. 4A is a chart illustrating a first example of a pulse generated by the configuration described in FIG. 3;

FIG. 4B is a chart illustrating a second example of a pulse generated by the configuration described in FIG. 3;

FIG. 5 is a diagram illustrating an electrical connection between a rotation detector and an external device through a communication line;

FIG. 6 is a chart illustrating an example of switching between a power supply period and a communication period;

FIG. 7 is a diagram illustrating a first configuration example of a data format that is encoded;

FIG. 8 is a diagram illustrating a second configuration example of the data format that is encoded;

FIG. 9 is a diagram illustrating an example of a vehicle provided with the rotation detection device;

FIG. 10 is a diagram illustrating a second configuration example of the encoder; and

FIG. 11 is a diagram illustrating a third configuration example of the encoder.

### DETAILED DESCRIPTION

Inventors of the present disclosure have found the following issues with regard to a rotation detection device.

Even when a technology described in JP-A-2011-27448 is applied, in a case where the detection resolution based on detection by the speed detection device is improperly selected, it may lead to a false operation. When the instruction from the multiplication change device may be incorrectly detected, the detection resolution of the pulse, which is generated by the pulse generation device, may be too high or too low. Furthermore, since the pulse, generated by the pulse generation device, is limited to the pulse based on the rotation speed of the rotator, it is difficult to add and output information other than the rotation speed of the rotator.

An embodiment according to the present disclosure will be explained with referring to drawings. Incidentally, unless otherwise specified, a phrase “connect” or “connection” denotes an electrical connection. Each drawing illustrates only essential elements to explain the present disclosure, and it is not necessarily to illustrate all elements in actual use. When a direction such as up, down, right, left, or the like is mentioned, the direction is based on a description in the drawings.

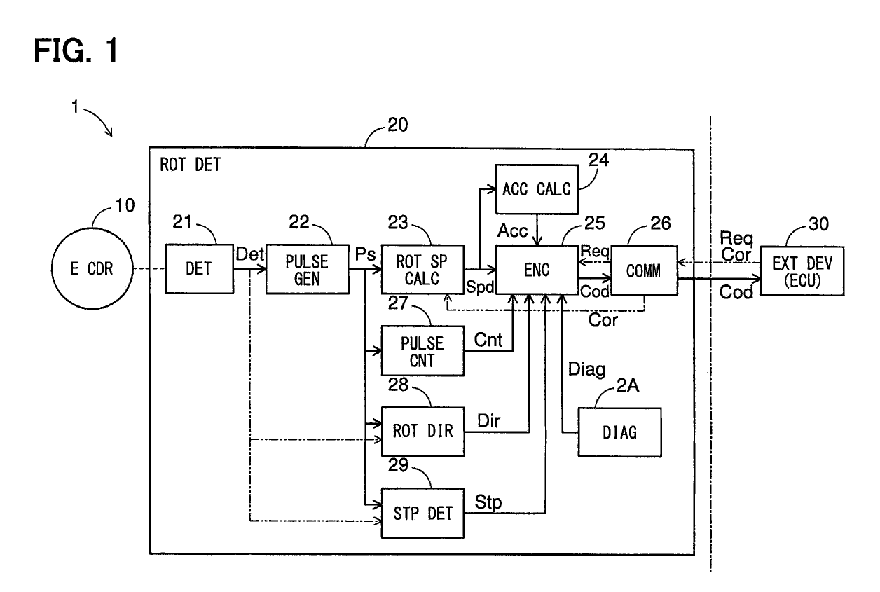

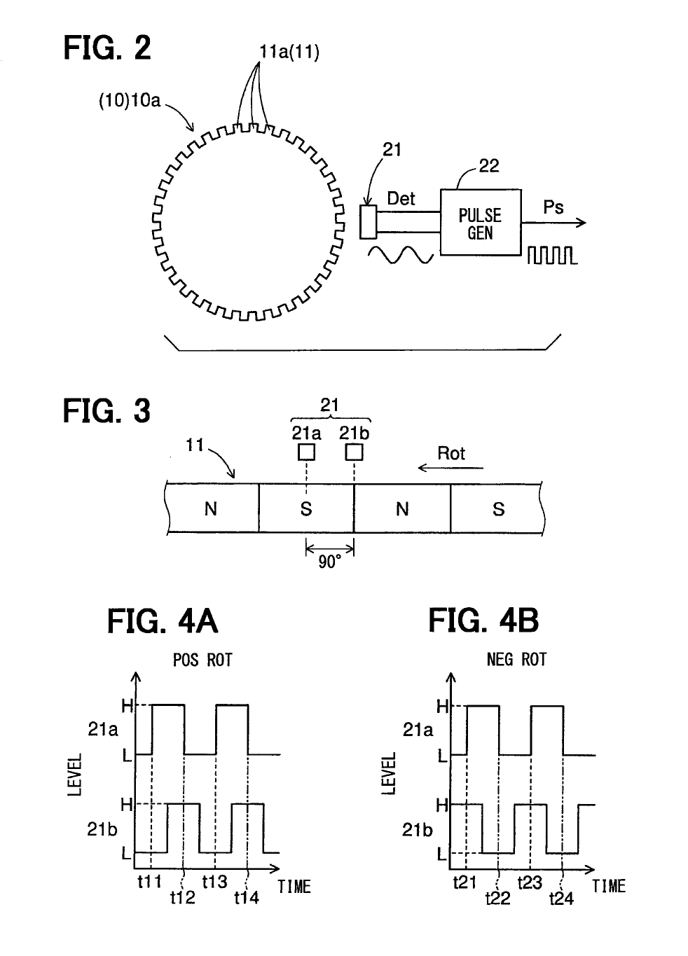

The present embodiment will be explained with referring to FIG. 1 to FIG. 9. A rotation detection device in FIG. 1 has an encoder 10, a rotation detector 20, or the like. The encoder 10 is rotatablely arranged and provided with multiple detection object portions 11a that are arranged in a circumferential direction (referring to FIG. 2). The number of the detection object portion 11a may be arbitrary set. According to a required resolution power, a predetermined number (e.g., 50 or 100) of the detection object portion 11a may be arranged.

The rotation detector 20 has a detection device 21, a pulse generation device 22, a rotation speed calculation device 23, an acceleration calculation device 24, an encoding device 25, a communication device 26, a pulse counter 27, a rotation direction determination device 28, a stop determination device 29, a self diagnosis device 2A, or the like. The above components may be configured independently each other. Alternatively, two or more than two components may be arbitrary selected to be configured integrally. The components will be explained briefly below.

The detection device 21 corresponds to a detection portion. The pulse generation device 22 corresponds to a pulse generation portion. The rotation speed calculation device 23 corresponds to a rotation speed calculation portion. The acceleration calculation device 24 corresponds to an acceleration calculation portion. The encoding device 25 corresponds to an encoding portion. The communication device 26 corresponds to a communication portion. The rotation direction determination device 28 corresponds to a rotation direction determination portion. The stop determination device 29 corresponds to a stop determination portion. The self diagnosis device 2A corresponds to a self diagnosis portion.

The encoder 10 and the detection device 21 will be explained with referring to FIG. 2. An. encoder 10a in FIG. 2 is an example of the encoder 10 in FIG. 1. The encoder 10a has a gear shape and a projection portion (a salient) on a circumference. The projection portion corresponds to the detection object portion 11a.

The detection device 21 detects a rotation of the encoder 10. For example, the detection device 21 is configured from a hall element, a magneto-resistance element (MRE), a magneto-impedance element (MI) or a coil. The MRE corresponds to an anisotropic magnetoresistance (AMR) element, a tunnel magneto-resistance (TMR) element, or the like. A bias magnet is arranged on a back surface of a detection element i.e., an opposite side from the detection element in the detection object portion. A relative magnetic force (e.g., a magnetic field or a magnetic flux) between the detection object portion 11a and the detection element is varied so that a detection signal Det with a sine wave (sin), a cosine wave (cos), or the like is outputted. Alternatively, as an encoder 10c in FIG. 11, it may be possible that an encoder has a magnet, and that a detection element does not have the bias magnet.

The pulse generation device 22 generates and outputs a pulse Ps. The pulse Ps is based on a detection signal Det (corresponding to an output signal) which is transmitted from the detection device 21. A configuration of the pulse generation device 22 may be configured arbitrary as long as the pulse generation device 22 changes a wave signal to a rectangular signal (i.e., the pulse Ps).

The rotation speed calculation device 23 in FIG. 1 calculates a rotation speed Spd of the encoder 10 according to the pulse Ps, which is generated by the pulse generation device 22. For example, the rotation speed calculation device 23 counts the total number of the pulse per unit time and calculates the rotation speed Spd. Length of the unit time may be arbitrary determined, and in the present embodiment, the length of the unit time is set to 6 milliseconds. Incidentally, although not shown in the drawings, a timing device (e.g., a timer or an oscillator) for timing the unit time is provided in the rotation detection device.

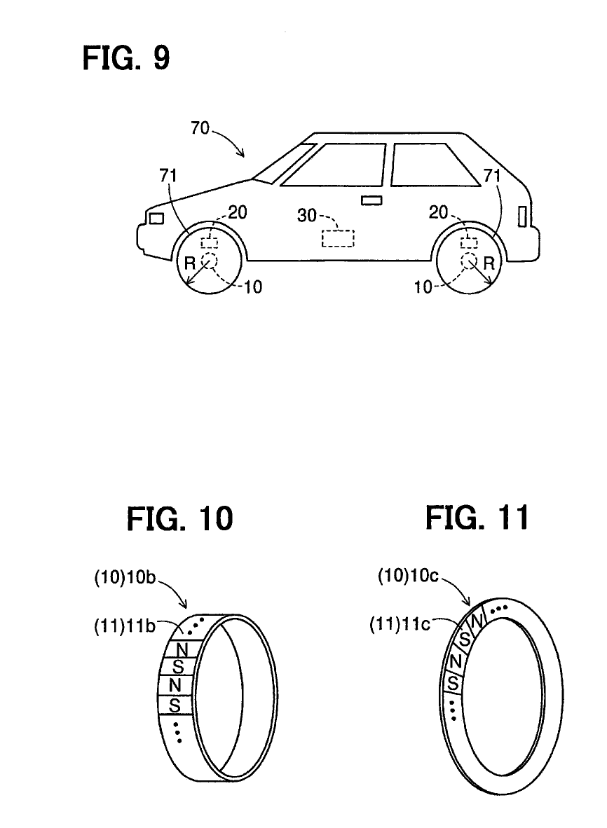

The rotation speed calculation device 23 may calculate the rotation speed Spd of a wheel 71 according to the pulse Ps, which is generated by the pulse generation device 22, and a wheel radius R described in FIG. 9. The wheel radius R is also referred to as a dynamic load radius of the wheel. The wheel radius R may be included into a signal (e.g., a request signal Req or a correction value Cor) that is transmitted from an external device 30, or may be set (or stored) into the rotation speed calculation device 23.

In addition, the rotation speed calculation device 23, as described as a two-dot chain line in FIG. 1, may calculate the rotation speed Spd of the wheel 71 according to the correction value Cor, which is transmitted from the external device 30 through the communication device 26. Under a predetermined condition (e.g., a case where a vehicle straights with a spare tire), when only a specific wheel 71 of the multiple wheels has a totally different rotation speed Spd compared with the other wheels 71, the rotation speed calculation device 23 calculates the rotation speed Spd of the wheel 71 according to the correction value Cor.

The acceleration calculation device 24 calculates the rotation acceleration Acc according to the rotation speed Spd, which is transmitted from the rotation speed calculation device 23. For example, it is possible to calculate the rotation acceleration Acc by calculating variation of the rotation speed Spd per unit time. The timing device may be included in the rotation speed calculation device 23, or may be provided separately.

The pulse counter 27 counts the pulse Ps, which is outputted from the pulse generation device 22. The number of the pulse Ps which is counted is stored into a counter as a counter value Cnt. The counting manner to count the pulse Ps may be a count-up way or a count-down way. A constitution (e.g., a register or an adder-subtractor) to count the pulse Ps is not limited. When a specific condition (e.g., initialization or stop) is satisfied, the counter value Cnt of the counter is set to an initial value (e.g., zero). Alternatively, the counter may be reset according to the request signal Req from the external device 30.

The rotation direction determination device 28 determines the rotation direction of the encoder 10 and outputs a rotation direction information Dir as a determination result. The rotation direction has, for example, a positive rotation (e.g., a rotation corresponding to a forward direction) and a negative rotation (e.g., a rotation corresponding to a backward direction). An example for determining the rotation direction will be explained with referring to FIG. 3, FIG. 4A and FIG. 4B. The detection device 21 in FIG. 3 has two detection portions 21a, 21b. The two detection portions 21a, 21b are arranged so that the detection signal Det has a shift of a predetermined angle (90 degrees in the present embodiment) between the two detection portions 21a, 21b. When the detection object portion 11 is moved to a predetermined direction (e.g., an arrow direction Rot) with a rotation of the encoder 10, the detection signal Det which is outputted from the detection portion 21a is shifted by the predetermined angle with respect to the detection signal Det which is outputted from the detection portion 21b.

As described in FIG. 4A and FIG. 4B, phases of the pulses Ps, which are outputted from the pulse generation device 22, are also shifted by the predetermined angle between the detection portions 21a, 21b. In FIG. 4A, an example illustrating the positive rotation is described. In FIG. 4B, an example illustrating the negative rotation is described. Times t11, t13, t21, t23, described as dashed lines, correspond to timing when the pulse Ps of the detection portion 21a rises up. At this timing, it is determined whether the pulse Ps of the detection portion 21b is in a high level (H) or in a low level (L). In an example of FIG. 4A, in a case where the pulse Ps of the detection portion 21b is in the low level, it is determined that the encoder 10 is in the positive rotation. In a case where the pulse Ps of the detection portion 21b is in the high level, it is determined that the encoder 10 is in the negative rotation as described in FIG. 4B.

Incidentally, the rotation direction may be determined by a timing (corresponding to times t12, t14, t22, t24 as described as two-dot chain line) when the pulse of the detection portion 21a drops down. In this case, a result of determination is reversed and the rotation directions in the high level and the low level are reversed. Similarly, the rotation direction of the encoder 10 may be determined by a rise up or a fall down of the detection portion 21b. Alternatively, the rotation direction of the encoder 10 may be determined by a rise up and a fall down of the pulses Ps of the detection portions 21a, 21b.

The stop determination device 29 determines whether the rotation of the encoder 10 has stopped. The stop determination device 29 outputs a stop determination information Stp. It is determined, according to the pulse Ps which is received in unit time, whether the rotation of the encoder 10 stops. Alternatively, the rotation of the encoder 10 is determined according to that a variation of the detection signal Det per unit time is equal to or less than a predetermined value. The detection signal Det is transmitted from the detection device 21. The rotation speed calculation device 23 or the acceleration calculation device 24 may be integrally provided to be used with the timing device, or may be provided separately.

The self diagnosis device 2A performs a self diagnosis. The self diagnosis device 2A outputs a self diagnosis information related to self diagnosis. Content (e.g., items) of the self diagnosis may be arbitrary set. For example, the content corresponds to one or more than one of a decrease of the magnetic force in the detection object portion 11, a malfunction of the detection device 21 (the detection portions 21a, 21b), a decrease of electric power required for operation of the rotation detector 20, another self diagnosis information, or the like. The decrease of the magnetic force in the detection object portion 11 can be detected whether an amplitude of the detection signal Det, which is transmitted from the detection device 21, is larger than a predetermined value. The malfunction of the detection device 21 (the detection portions 21a, 21b) can be detected whether the pulse Ps is generated in a condition where the detection signal Det is outputted. The decrease of the electric power required for operation of the rotation detector 20 can be detected whether a capacitance of a power source (e.g., a capacitor or secondary battery) which is provided in the rotation detector 20 is larger than a predetermined value.

The encoding device 25 encodes information that includes at least the rotation speed Spd, which is calculated by the rotation speed calculation device 23, and the counter value Cnt of the pulse counter 27. In addition, the information may include the rotation acceleration Acc, which is calculated by the acceleration calculation device 24, the rotation direction information Dir, which is determined by the rotation direction determination device 28, the stop determination information Stp, which is determined by the stop determination device 29, or the self diagnosis information, which is diagnosed by the self diagnosis device 2A. An example of a data format 50 by the encoding device 25 will be described below (referring to FIG. 7 and FIG. 8).

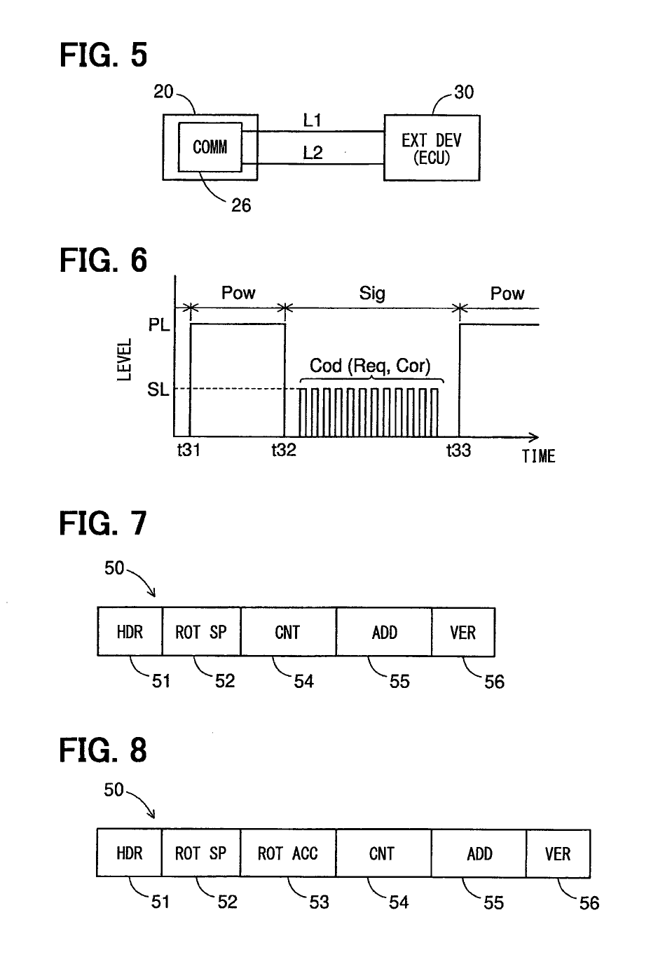

The communication device 26 communicates an encoded information Cod, which is encoded by the encoding device 25, through unidirectional communication or interactive communication with the external device 30. The communication performed with the external device 30 is not limited to a cable communication (e.g., wire communication) or a radio communication (e.g., wireless communication). The communication performed with the external device 30 may include a LAN communication (e.g., CAN or the like which is a kind of in vehicle LAN). The external device 30 may be a single or more than one. An example of the cable communication will be described below (referring to FIG. 5).

Herein, the unidirectional communication denotes a communication from the rotation detector 20 to the external device 30. The interactive communication includes a form in which, according to the request signal Req which is transmitted from the external device 30, the encoding device 25 selects and encodes information as described in the two-dot chain line in FIG. 1. Furthermore, in the form of the interactive communication, the encoded information Cod, which is encoded by the encoding device 25, is transmitted to the external device 30. Thus, the rotation detector 20 returns only the information which the external device 30 requests. In either of the unidirectional communication and the interactive communication, a timing of the communication (e.g., transmission or reception) may be set arbitrary.

In an example of the cable communication described in FIG. 5, the communication device 26 of the rotation detector 20 and the external device 30 are connected by communication lines L1, L2 (corresponding to a two-wire communication line). For example, the communication is performed by using electrical potential difference between the communication line L1 and the communication line L2. It may be possible that electric power is supplied and that the information is transmitted by the communication. For example, as described in FIG. 6, an electric power supply period Pow is provided separately from a communication period Sig. In the communication period Sig, the encoded information or the like is transmitted from the rotation detector 20 to the external device 30. In the electric power supply period Pow, in order to ensure the electric power for operating the rotation detector 20, the electric power is supplied from the external device (or another electric power source) to the rotation detector 20. As described in FIG. 6, a signal level SL for the communication is different from an electric power level PL for supplying the electric power, in general. However, the signal level SL may be equal to the electric power level PL. In addition, the signal level SL may be superimposed and transmitted with the electric power level PL.

FIG. 7 and FIG. 8 illustrate an example of information (corresponding to a data format) which is transmitted from the rotation detector 20 to the external device 30 in the communication which is performed in the communication period Sig. The data format 50 described in FIG. 7 includes a header 51, a rotation speed 52, a counter value 54, an additional information 55, a verification code 56, or the like. The data format 50 described in FIG. 8 includes a rotation acceleration 53, in addition to the data format 50 in FIG. 7. The communication may be performed by the data formats 50 in FIG. 7 or FIG. 8. Alternatively, the communication may be performed with switching between the data format 50 in FIG. 7 and the data format 50 in FIG. 8. When the communication is performed by the data format 50 corresponding to a request from the external device 30, the data format 50 is not limited to a data element described in FIG. 7 or FIG. 8. Each data element described in FIG. 7 and FIG. 8 will be briefly described below.

The header 51 is information related to the data format 50. For example, the information of the header 51 includes data length of the data format 50, a device to communicate, an identification code (e.g., address or the like) of the rotation detector 20. The rotation speed 52 is the rotation speed Spd, which is calculated by the rotation speed calculation device 23. The rotation acceleration 53 is the rotation acceleration Acc, which is calculated by the rotation acceleration calculation device 24. The counter value 54 is the counter value Cnt, which is counted by the pulse counter 27. The additional information 55 includes one or more of information of the rotation direction information Dir, which is determined by the rotation direction determination device 28, the stop determination information Stp, which is determined by the stop determination device 29, the self diagnosis information Stp, which is diagnosed by the self diagnosis device 2A, or the like. The verification code 56 is information to verify whether a data content is changed by an effect of noise or the like during communication. For example, the verification code 56 corresponds to a parity bit or an error correcting code (ECC).

Incidentally, the information corresponding to the request signal Req, which is transmitted from the external device 30, may be included into the data format 50 as the additional information 55. The data format 50 may not have the additional information 55. When the rotation speed Spd and the rotation acceleration Acc are calculated from both of the encoder 10 and the wheel 71, the rotation speed Spd and the rotation acceleration Acc that are calculated from either the encoder 10 or the wheel 71 may be the rotation speed 52 and the rotation acceleration 53, and the rotation speed Spd and the rotation acceleration Acc that are calculated from the other may be included into the additional information 55.

The rotation detection device 1 (i.e., the encoder 10 and the rotation detector 20) is placed to a vehicle 70 as described in FIG. 9. In an example of FIG. 9, the wheel 71 has the encoder 10 and the rotation detector 20. The external device 30 receives the encoded information Cod which is transmitted from the four rotation detectors 20. The external device 30 processes the encoded information Cod to figure out a state (e.g., the vehicle speed) of the vehicle.

According to the above described embodiment, the following advantages will be obtained.

(1) In the rotation detection device 1 having the encoder 10 and the rotation detector 20, the rotation detector 20 has the detection device 21, the pulse generation device 22, the rotation speed calculation device 23, the pulse counter 27, the encoding device 25, the communication device 26 (referring to FIG. 1). The detection device 21 detects a rotation of the encoder 10. The pulse generation device 22 generates and outputs the pulse Ps based on the detection signal Det. The rotation speed calculation device 23 calculates the rotation speed Spd of the encoder 10 according to the pulse Ps, which is generated by the pulse generation device 22. The pulse counter 27 counts the pulse Ps. The encoding device 25 encodes information that includes the rotation speed Spd, which is calculated by the rotation speed calculation device 23, and the counter value Cnt of the pulse counter 27. The communication device 26 communicates the encoded information Cod, which is encoded by the encoding device 25, through unidirectional communication or interactive communication with the external device 30. According to this configuration, the encoding device 25 encodes the information that includes the rotation speed Spd, which is calculated by the rotation speed calculation device 23, and the counter value Cnt of the pulse counter 27, and the encoded information Cod is transmitted to the external device 30 by the communication device 26. It may be possible to prevent a false operation accompanied by a switching of the resolution power. Since the encoded information Cod is outputted without any instruction, it may be possible to prevent incorrect detection due to mistake associated with a resolution power switching, which is caused by improper reception of the instruction. Thus, it is possible to improve a reliability of the rotation speed Spd or the like. Since a rotation speed calculation is performed in the rotation detector 20, the calculation load on the external device 30 reduces. Furthermore, since the information other than the rotation speed Spd is added and outputted, convenience is improved. For example, it is possible to easily calculate a vehicle travel distance in very low speed due to the counter value Cnt, which is transmitted with the rotation speed Spd. It is possible that the counter value Cnt is used in a system where a movement of the vehicle is controlled from a traveling state to a stop state.

(2) The rotation speed calculation device 23 calculates the rotation speed Spd of the wheel 71 based on the pulse Ps, which is generated by the pulse generation device 22, and the wheel radius R or the dynamic load radius (referring to FIG. 1). According to this configuration, the rotation speed Spd of the wheel 71 is calculated based on the wheel radius R or the dynamic load radius. It is possible to obtain the rotation speed Spd of the wheel 71 which rotates actually, and to reduce the calculation load on the external device 30.

(3) The rotation speed calculation device 23 calculates the rotation speed Spd of the wheel 71 based on the correction value Cor (referring to FIG. 1). According to this configuration, when, under the predetermined condition (e.g., a case where a vehicle straights), at least one of the wheel 71 of the multiple wheels has a totally different rotation speed Spd compared with the other wheels 71 (e.g., the at least one of the wheel 71 has a spare tire), the rotation speed Spd of the wheel 71 is calculated based on the correction value Car. Thus, it is possible to obtain the rotation speed Spd of the wheel 71 appropriately. Alternatively, it is possible to obtain a more correct wheel speed by combining with a tire pressure monitoring system (TPMS) and by performing a subsidiary calculation of the rotation speed Spd based on the correction value Cor which is generated based on the tire pressure information.

(4) The rotation detection device 1 includes the acceleration calculation device 24 for calculating the rotation acceleration Acc based on the rotation speed Spd, which is transmitted from the rotation speed calculation device 23. The encoding device 25 encodes the rotation acceleration Acc, which is calculated by the acceleration calculation device 24. The communication device 26 communicates the encoded information Cod, which includes the rotation speed Spd and the rotation acceleration Acc (referring to FIG. 1). According to this configuration, since the rotation speed Spd and the acceleration speed Add are obtained, it is possible that the calculation load on the external device 30 reduces.

(5) The rotation detection device 1 includes the rotation direction determination device 28 for determining a rotation direction of the encoder 10. The encoding device 25 encodes the rotation direction information Dir, which is determined by the rotation direction determination device 28. The communication device 26 communicates the encoded information Cod which includes the rotation direction information Dir (referring to FIG. 1). According to this configuration, since the rotation direction information Dir related to the rotation direction of the encoder 10 is obtained, it is possible that the calculating load on the external device 30 reduces.

(6) The rotation detection device 1 includes the stop determination device 29 for determining whether the encoder 10 stops rotating. The encoding device 25 encodes the stop determination information Stp, which is determined by the stop determination device 29. The communication device 26 communicates the encoded information Cod that includes the stop determination information Stp (referring to FIG. 1). According to this configuration, since it is determined that the encoder 10 stops rotating by the stop determination information Stp, it is possible that the calculating load on the external device 30 reduces.

(7) The rotation detection device 1 includes the self diagnosis device 2A for diagnosing itself. The encoding device 25 encodes the self diagnosis information Diag which is related to the self diagnosis performed by the self diagnosis device 2A. The communication device 26 communicates the encoded information Cod that includes the self diagnosis information Diag (referring to FIG. 1). According to this configuration, since a condition of the encoder 10 or the rotation detector 20 is known by the self diagnosis information Diag, it is possible that a vehicle control system (e.g., ABS, ESC or the like) which utilizes a signal of the rotation detector 20 is informed difficulty as soon as possible. It is possible to safely stop the vehicle control system in addition to preventing a false operation of the vehicle control system due to an abnormal signal. Therefore, it is possible that the calculating load on the external device 30 reduces.

(8) The communication device 26 communicates the encoded information Cod which includes information based on the request signal Req transmitted from the external device 30 (referring to FIG. 1). According to this configuration, since the encoded information Cod based on the request signal Req is transmitted to the external device 30, it is possible to obtain information which the external device 30 requires.

(9) The communication device 26 wirelessly communicates with the external device 30 (referring to FIG. 1). According to this configuration, since it is unnecessary to place a communication line (or a communication cable) between the rotation detector 20 and the external device 30, it is possible to arbitrary place the rotation detector 20 as long as the communication is established. In addition, since it is unnecessary to wire the communication line, it is possible to reduce a working process.

(10) The communication device 26 connects with the external device 30 through the two-wire communication lines L1, L2 (referring to FIG. 5). According to this configuration, it is possible to keep the number of wirings to a minimum when the rotation detector 20 communicates with the external device 30. In addition, since the electric power supply period Pow is provided independently from the communication period Sig (referring to FIG. 6), it is possible that the rotation detector 20 is operated surely.

(11) The encoder 10 includes more than a predetermined number of the detection object portions 11 (e.g., the detection object portions 11areferring to FIG. 1 and FIG. 2). According to this configuration, when the vehicle 70 travels slowly or the vehicle speed reduces until the vehicle 70 stops, the pulse Ps is generated based on the detection signal Det, which is outputted from the detection device 21. Thus, the rotation speed Spd or the like is correctly obtained regardless of the vehicle speed, and the calculation load on the external device 30 does not increase.

(12) The vehicle 70 includes the encoder 10 and the rotation detector 20 (referring to FIG. 1 and FIG. 9). According to this configuration, it is possible by the rotation detector 20 that the false operation, the incorrect detection or the like is prevented to improve a reliability of the rotation detection device. It is possible that the rotation detector 20 adds and outputs information other than the vehicle speed.

### Other Embodiment

Although the embodiment according to the present disclosure is described above, it should be noted that the present disclosure is not limited to the above embodiment. The present disclosure will be applied to other various embodiments within a scope of the present disclosure.

In the above described embodiment, the encoder 10a has the gear shape and the projection portion on the circumference (referring to FIG. 2). Alternatively, the detection object portion may have another shape. For example, an encoder 10b in FIG. 10, an encoder 10c in FIG. 11, or the like corresponds to the another shape. The encoder 10b has a cylinder shape and multiple detection object portions 11b. The multiple detection object portions 11b are arranged on an outer periphery (all or a part of the outer periphery) of the encoder 10b and are magnetized as a south pole or a north pole alternately. A shape example in FIG. 10 has a flat outer periphery. However, the outer periphery may have asperity like a rim, for example. The encoder 10c has an annular shape and multiple detection object portions 11c. The multiple detection object portions 11c are arranged on a surface and are magnetized as the south pole or the north pole alternately. Alternatively, it may possible to arrange a magnetized projection portion, similar to FIG. 10. According to the above configurations, it is possible that the detection device 21 outputs the detection signal Det, according to variation of relative magnetic force to the detection object portion (e.g., 11b or 11c) during the rotation of the encoder (e.g., 10b or 10c). Therefore, it is possible to obtain the technical effects similar to the above embodiment.

In the above embodiment, the encoder 10 is detected by the detection device 21 (referring to FIG. 1 and FIG. 2). Alternatively, another detection object may be detected. For example, another detection object corresponds to a gear rotor, a magnetic encoder, a rotary encoder, or the like. A detection process for another detection object is similar to the encoder 10. In the detection process, a rotation is detected by using a magnetic field of the bias magnet provided in the detection device 21. Therefore, it is possible to obtain the technical effects similar to the above embodiment. It is possible to use a resolver, in which a detection is performed though a coil placed in a rotation portion and another coil placed in a non-rotation portion. Furthermore, it is possible that a detection device does not use magnetism. For example, the detection device includes an optical encoder.

In the above embodiment, the wheel 71 includes the rotation detection device 1 (especially, the encoder 10), and detects the rotation of the wheel 71 (referring to FIG. 1 and FIG.9). Alternatively, a member other than the wheel 71 may be used to detect a rotation of a rotating object in the vehicle 70. For example, the rotating object corresponds to a shaft (especially, a crankshaft or a drive shaft), a motor as a driving source (especially, a rotating shaft such as a main axis or the like), a power transmission portion (especially, a cam, a pinion, a gear, or the like), or the like. Another rotating object other than the wheel 71 detects the rotation speed Spd or the like, similar to the wheel 71. Therefore, it is possible to obtain the technical effects similar to the above embodiment.

In the above embodiment, the vehicle 70 is a four wheel vehicle (referring to FIG. 9). Alternatively, the vehicle 70 may be another type of the vehicle. The another type of the vehicle may include a multi wheel vehicle such as a trailer, a two wheel vehicle, a small motor vehicle, a rail car or the like. Another type of the vehicle detects the rotation speed Spd of the wheel 71 or the rotating object. Therefore, it is possible to obtain the technical effects similar to the above embodiment.

A rotation detection device includes an encoder that is rotatably arranged, a plurality of detection object portions, and a rotation detector. The plurality of detection object portions are provided in the encoder and arranged in a circumferential direction of the encoder. The rotation detector detects rotation of the encoder. The rotation detector includes a detection portion, a pulse generation portion, a rotation speed calculation portion, a pulse counter, an encoding portion, and a communication portion. The detection portion detects the rotation of the encoder. The pulse generation portion generates a pulse based on a detection signal that is outputted from the detection portion. The rotation speed calculation portion calculates a first rotation speed of the encoder based on the pulse. The pulse counter counts the pulse. The encoding portion encodes information that includes the first rotation speed and a counter value of the pulse counter. The communication portion communicates encoded information, which is encoded by the encoding portion, through unidirectional communication or interactive communication with an external device.

According to this configuration, the encoding portion encodes the information that includes the rotation speed, which is calculated by the rotation speed calculation portion, and the counter value of the pulse counter. The encoded information is transmitted to the external device by the communication portion. It may be possible to prevent a false operation accompanied by a switching of the resolution power. Since the encoded information is outputted without any instruction, it may be possible to prevent incorrect detection due to mistake associated with a resolution power switching, which is caused by improper reception of the instruction. Thus, it is possible to improve a reliability of the rotation speed or the like. Since a rotation speed calculation, which is conventionally perform by the external device, is performed in the rotation detector, the calculation load on the external device reduces. Furthermore, since the information other than the rotation speed Spd is added and outputted, convenience is improved.

In the rotation detection device according to the present disclosure, the rotation speed calculation portion calculates a rotation speed of a wheel of a vehicle, based on the pulse and a wheel radius or a dynamic load radius of the vehicle.

According to this configuration, the rotation speed of the wheel of the vehicle is calculated based on the wheel radius or the dynamic load radius. It is possible to obtain the rotation speed (e.g., km/h) of the wheel which rotates actually, and to reduce the calculation load on the external device.

In the rotation detection device according to the present disclosure, the rotation speed calculation portion corrects the second rotation speed based on a correction value.

According to this configuration, when, under a predetermined condition (e.g., a case where a vehicle straights), at least one of the wheel of the multiple wheels has a totally different rotation speed compared with the other wheels (e.g., the at least one of the wheel has a spare tire), the rotation speed of the wheel is calculated based on the correction value. Thus, it is possible to obtain the rotation speed of the wheel appropriately. Alternatively, it is possible to obtain a more correct wheel speed by combining with a tire pressure monitoring system (TPMS) and by performing a subsidiary calculation of the rotation speed based on the correction value which is generated based on the tire pressure information.

Incidentally, it may be possible that the encoder and the rotation detector are placed separately, or placed integrally. Each component configuring the rotation detector may be a hardware such as a wired logic configuration, or may a software that executes a program performed by a CPU. The detection object portion may be an arbitrary form (i.e., a shape, material, placement, the number of items, or the like) as long as the rotation of the encoder is detected. A form of the encoder is not limited as long as the encoder is rotatably configured. The communication may correspond to a wired communication with cable (e.g., communication line), or correspond to be a wireless communication without cable. The external apparatus may correspond to an electric control unit (ECU) or another process apparatus (e.g., vehicle navigation apparatus, a beacon, a computer or the like) other than the ECU.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A rotation detection device comprising:
an encoder that is rotatably arranged;
a plurality of detection object portions that are provided in the encoder and arranged in a circumferential direction of the encoder; and
a rotation detector for detecting rotation of the encoder, wherein
the rotation detector includes:
a detection portion for detecting the rotation of the encoder;
a pulse generation portion for generating a pulse based on a detection signal that is outputted from the detection portion;
a rotation speed calculation portion for calculating a first rotation speed of the encoder based on the pulse;
a pulse counter for counting the pulse;
an encoding portion for encoding information that includes the first rotation speed and a counter value of the pulse counter; and
a communication portion for communicating encoded information, which is encoded by the encoding portion, through unidirectional communication or interactive communication with an external device.

2. The rotation detection device according to claim 1, wherein
the rotation speed calculation portion calculates a second rotation speed of a wheel of a vehicle, based on the pulse and a wheel radius or a dynamic load radius of the vehicle.

3. The rotation detection device according to claim 2, wherein
the rotation speed calculation portion corrects the second rotation speed based on a correction value.

4. The rotation detection device according to claim 1, further comprising
an acceleration calculation portion for calculating a rotation acceleration based on the first rotation speed, which is transmitted from the rotation speed calculation portion, wherein
the encoding portion encodes the rotation acceleration, which is calculated by the acceleration calculation portion, and
the communication portion communicates the encoded information which includes the first rotation speed and the rotation acceleration.

5. The rotation detection device according to claim 1, further comprising
a rotation direction determination portion for determining a rotation direction of the encoder, wherein
the encoding portion encodes a rotation direction information item which is determined by the rotation direction determination portion, and
the communication portion communicates the encoded information which further includes the rotation direction information item.

6. The rotation detection device according to claim 1, further comprising
a stop determination portion for determining whether the encoder has stopped rotating, wherein
the encoding portion encodes a stop determination information item which is determined by the stop determination portion, and
the communication portion communicates the encoded information which further includes the stop determination information item.

7. The rotation detection device according to claim 1, further comprising
a self diagnosis portion for performing a self diagnosis, wherein
the encoding portion encodes a self diagnosis information item related to the self diagnosis, and
the communication portion communicates the encoded information which further includes the self diagnosis information item.

8. The rotation detection device according to claim 1, wherein
the communication portion communicates the encoded information which includes an information item based on a request signal which is transmitted from the external device.

9. The rotation detection device according to claim 1, wherein
the communication portion wirelessly communicates with the external device.

10. The rotation detection device according to claim 1, wherein
the communication portion electrically connects with the external device through a two-wire communication line.

11. The rotation detection device according to claim 1, wherein
the number of the plurality of the detection object portions is equal to or larger than a predetermined number.

12. The rotation detection device according to claim 1, wherein
the encoder is installed to a vehicle, and
the rotation detector is installed to the vehicle.

13. The rotation detection device according to claim 1, wherein
the rotation speed calculation portion calculates a second rotation speed of a wheel of a vehicle, based on the pulse and a wheel radius or a dynamic load radius of the vehicle,
the rotation detection device further comprises:
an acceleration calculation portion for calculating a first rotation acceleration based on the first rotation speed, which is transmitted from the rotation speed calculation portion,
the acceleration calculation portion further calculates a second rotation acceleration based on the second rotation speed,
the encoding portion encodes the first rotation speed or the second rotation speed, which are calculated by the acceleration calculation portion,
the communication portion communicates the encoded information which includes:
the first rotation speed and the first rotation acceleration; and
the second rotation speed and the second rotation acceleration.
